(19) United States
(12) Patent Application Publication
(10) Pub. No.: US 2003/0072708 A1
(43) Pub. Date: Apr. 17, 2003

(54) Method for dual-fuel operation of a fuel-rich catalytic reactor

(76) Inventors: Lance L. Smith, North Haven, CT (US); Shahrokh Etemad, Trumbull, CT (US); Marco J. Castaldi, Bridgeport, CT (US); Hasan Ul Karim, Bethany, CT (US); William C. Pfefferle, Madison, CT (US)

Correspondence Address: McCormick, Paulding & Huber, City Place II, 185 Asylum Street, Hartford, CT, 06103-3402, US

(21) Appl. No.: 10/246,516

(22) Filed: Sep. 18, 2002

Related U.S. Application Data
(60) Provisional application No. 60/323,488, filed on Sep. 19, 2001.

(51) Int. Cl. B01J 12/00

(52) U.S. Cl. 423/659

(57) ABSTRACT

The present invention is a method for operating a fuel-rich catalytic reactor in a catalytic combustion system, wherein two different fuels having dissimilar reactivity are consecutively used. In this method, a fuel-rich fuel/air mixture comprising a first fuel contacts a catalyst to create a product stream and a heat of reaction. The reactor is operated such that mass transfer of oxygen to the catalyst surface limits the rate of catalytic reaction. The catalyst is backside cooled by a cooling stream comprising air that extracts at least a portion of the heat of reaction before contacting the product stream. The cooling stream flow is sufficient to completely combust all of the remaining fuel. A second fuel is then substituted for the first fuel, and the steps are repeated.

### CROSS-REFERENCE TO OTHER APPLICATIONS

This application claims priority to U.S. Provisional Application No. 60/323,488 entitled “Method and Apparatus for a Fuel-Rich Catalytic Reactor” filed Sep. 19, 2001. The disclosure contained within the provisional application is hereby incorporated by reference in its entirety.

This invention was developed under DOE Grant DE-FC02-98CH10939 entitled “Catalytic Combustion Enabling Technologies Development Program for Industrial Gas Turbine Systems”. The government may have certain rights herein.

### BACKGROUND OF THE INVENTION

The present invention relates generally to catalytic combustion and more particularly to a method for consecutively combusting different fuels within the same catalytic reactor.

### BRIEF DESCRIPTION OF THE RELATED ART

Catalytic combustors generally react fuel with oxygen in two stages. The first stage is catalytic reaction, which takes place upon a catalyst surface. The second stage is gas-phase reaction, in which fuel and oxygen react away from the catalyst surface, without the presence of a catalyst. Thus, any fuel that does not contact the catalyst surface is ultimately burned in the gas-phase, so that combustion completion is achieved.

Combustion completion in the gas-phase, including burnout of intermediate products such as CO and CH₄, generally requires temperatures greater than approximately 1100 to 1200° C. for carbonaceous fuels. Unfortunately, temperatures of 1100 to 1200° C. are well above the material temperature limits of metallic catalyst substrates. Accordingly, there is a need to control and limit catalyst operating temperature to a value below the final combustion temperature, regardless of specific fuel type. It is generally desired to limit catalyst temperature without heat extraction to external fluids (i.e. fluids other than the air or fuel to be used for combustion completion), to ensure good combustion efficiency and minimal complexity. Thus, without such external heat extraction, only a portion of the total fuel can be reacted in the catalyst bed.

One method for limiting the amount of fuel reacted in the catalyst bed is to stage the fuel injection, so that only a portion of the fuel passes through the catalyst bed (with the remainder being injected downstream). Unfortunately, issues arise of fuel injection and mixing in the hot-gas path downstream of the catalyst. Thus, it is generally considered preferable to pass all of the fuel through the catalyst bed. Such use of a single fuel stage, however, requires some means of ensuring only partial combustion of the fuel as it passes through the catalyst bed. For maximum versatility, it is desirable that this partial (versus full) combustion is ensured for multiple fuel types, regardless of the fuels' reactivity, and regardless of whether reactions occur on the catalyst or in the gas phase. Such fuel versatility has been difficult to achieve in many prior-art catalytic combustion systems.

Even when partial (versus full) combustion is ensured, additional means for limiting catalyst temperature is also required, such as catalyst cooling by combustion air or fuel or both. This is because partial (versus full) combustion only limits the average gas temperature at the catalyst exit, but does not necessarily limit peak gas temperature or catalyst operating temperature.

In fact, if catalytic reactions are fast, peak catalyst temperatures are near the fuel/air mixture's adiabatic flame temperature. This situation occurs when the rate of reaction at the catalyst surface is fast compared to the rate at which reactants (fuel and oxygen) are transferred to the surface, so that fuel and oxygen are reacted to products almost immediately upon contact with the catalyst, rapidly releasing heat. Operation at such high rates of reaction is called “mass transfer limited” operation, since the net reaction rate (including both the mass transfer and the catalytic reaction processes) is ultimately limited by the rate at which reactants (mass) are transferred to the surface.

Thus, one method of reducing peak catalyst temperatures is to reduce the rate of reaction at the catalyst surface (by using a less active catalyst for example) such that the reactor does not operate mass transfer limited, and instead operates “kinetically limited” with net reaction rate ultimately limited by reaction rate (kinetics) at the catalyst surface. This reduces the rate of heat release at the catalyst surface, and reduces the catalyst temperature. However, limiting catalyst temperature by control of catalyst activity has the disadvantage that reaction rate (and hence catalyst temperature) will vary with fuel type, depending on the fuels' catalytic reactivity. Thus, the catalyst may operate safely within material temperature limits on one fuel type, but may exceed material temperature limits on a different fuel type. A need exists to safely limit peak catalyst temperatures regardless of fuel type, and without heat extraction to fluids external to the combustion process.

It has now been found that a catalytic combustion system employing a fuel-rich catalytic reaction, wherein the catalyst is operated oxygen mass transfer limited and backside cooled by the remaining combustion air, can operate with safe catalyst temperatures on two different fuels having dissimilar reactivity.

### SUMMARY OF THE INVENTION

The present invention is a method for operating a fuel-rich catalytic reactor in a catalytic combustion system, wherein two different fuels having dissimilar reactivity are consecutively used. Different fuels under consideration include conventional hydrocarbon fuels of commercial interest, such as methane natural gas, propane, gasoline, Jet fuel, and Diesel fuel, as well as oxygenated hydrocarbons such as methanol and ethanol. In terms of reactivity, these fuels may be distinguished by their auto-ignition delay times in air (non-catalytic), as is well known in the art. For example, the auto ignition delay time for methane is approximately two orders of magnitude greater than that of natural gas which in turn is approximately three orders of magnitude greater than that of diesel fuel. Precious-metal-based catalysts such as alumina-supported platinum are active to all of these fuels, as is also well known in the art.

Another useful characterization of a fuel is its heat release per mole of oxygen reacted. In general, about 100 kilocalories of energy are released when one mole of O₂ is reacted with conventional hydrocarbon-based fuels such as natural gas or gasoline to create the full combustion products CO₂ and H₂O. The method of the present invention is most useful for fuels having similar heat release per mole of oxygen reacted. Most preferably, the method of the present invention is used for conventional hydrocarbon fuels and hydrocarbon oxygenates which release about 90-110 kilocalories of energy per mole of oxygen reacted.

In one embodiment of the method of the present invention, a first fuel is mixed with first stream comprising air to create a first fuel-rich fuel/air mixture and is contacted with a catalyst to create a first product stream and a heat of reaction. The first product stream is backside cooled by a cooling stream comprising a second air stream and then contacted with the catalyst cooling stream. Both the first and second streams comprising air may also contain steam, other diluents and minor proportions of fuel. A second fuel, having dissimilar reactivity as compared to the first fuel, is then substituted for the first fuel to create a second fuel-rich fuel/air mixture in place of the first fuel-rich fuel/air mixture. The second fuel-rich fuel/air mixture is contacted with the catalyst to create a second product stream and a heat of reaction. The second product stream is backside cooled by the cooling stream and then contacted with the catalyst cooling stream. The term product stream as used herein means the effluent from the fuel-rich fuel oxidation process comprising the remaining fuel values after reaction of the entering fuel/air mixture, where the remaining fuel values can include residual fuel (entering fuel unchanged) and/or fuel partial oxidation products (entering fuel partially oxidized but less than fully combusted).

Because a fuel-rich fuel/air mixture contains insufficient oxygen to fully combust the fuel contained therein, only a portion of the fuel can be fully combusted to final combustion products (CO₂ and H₂O for hydrocarbon-based fuels), even if catalytic or gas-phase reaction rates are infinitely fast. Thus, partial (versus full) combustion is ensured regardless of the type of fuels chosen (regardless of the fuels' reactivity, and regardless of whether reactions occur on the catalyst or in the gas phase).

In a preferred embodiment of the method of the present invention, the cooling stream backside cools the catalyst and reaction heat is transferred to the cooling stream, before contacting the product stream. The cooling air stream is of sufficient flow rate that if it were mixed with the product stream the resulting mixture would be a fuel-lean fuel/air mixture. The cooling stream may be mixed with the product stream after contact if desired, and may then be combusted if desired. Alternatively, the product stream's remaining fuel values may burn upon contact with the cooling stream prior to mixing, if desired.

It is a feature of the method that the catalyst can be backside cooled by the cooling stream. Backside cooling is a technique whereby the catalyst is on one side of a substrate and the cooling stream is brought into contact with the other side of the substrate. Backside cooling allows the catalyst to operate at a temperature lower than the adiabatic flame temperature of the fuel-rich fuel/air mixture, even when the catalytic reactor is operated in a mass transfer limited regime. A catalytic reactor is said to operate in a mass transfer limited regime when the catalytic reaction rate is sufficiently fast that the net rate of conversion of reactants is limited by mass transfer of reactants from the bulk fuel/air mixture stream to the catalyst surface. For a fluid stream with an effective Lewis number near unity (ratio of thermal diffusivity to mass diffusivity), a catalyst surface operating in a mass transfer limited regime will reach temperatures near the adiabatic flame temperature of the reaction mixture unless cooling is provided.

It is a requirement of the method that the catalytic reactor operate oxygen mass transfer limited, meaning that the net rate of catalytic reaction is limited by the rate of mass transfer of oxygen to the catalyst surface. A reactor operates under oxygen mass transfer limited conditions when the fuel/air mixture is fuel-rich and the catalytic reaction rate is sufficiently fast that oxygen is reacted almost immediately upon reaching the catalyst surface. Mass transfer of oxygen to the surface is proportional to oxygen concentration. Thus, as is well known in the art, the rate of the catalytic reaction may be limited by limiting the maximum oxygen concentration in the fuel-rich, fuel-air mixture. Note that only a portion of the fuel at the catalyst surface is reacted, because under fuel-rich conditions there is insufficient oxygen to react all of the fuel. Under oxygen mass transfer limited conditions the net rate of reaction is not controlled by the catalyst activity or a fuel's reactivity, and is therefore independent of fuel type.

For combustion reactions, which are highly exothermic, the oxygen mass transfer limitation establishes the rate of heat release at the catalyst surface. This rate of heat release, in balance with catalyst cooling by heat transfer into both the reacting fuel-rich stream and the cooling stream, establishes the catalyst operating temperature. Thus, for a given cooling rate and a given mass transfer rate of oxygen, operation under oxygen mass transfer limited conditions fixes the catalyst operating temperature regardless of the catalyst activity or a fuel's reactivity, assuming similar exothermicity for different fuels. Under oxygen mass transfer limited conditions, exothermicity is best measured on the basis of heat release per mole of oxygen reacted with a given fuel to create the full combustion products CO₂ and H₂O. As discussed earlier, most conventional hydrocarbon-based fuels have similar exothermicity—i.e. they have similar heat release per mole of oxygen reacted to full combustion products (in the range of about 90-110 kcal/mole of O₂ reacted). Under the method of the present invention, it is preferred that fuels are used having a heat release per mole of oxygen reacted between about 80 and 120 kcal/mole of O₂ reacted, and it is most preferred that fuels are used having a heat release per mole of oxygen reacted between about 90 and 110 kcal/mole of O₂ reacted.

The method of the present invention is preferably practiced using the backside-cooled catalytic reactor apparatus disclosed in U.S. Pat. No. 6,394,791 and No. 6,358,040. In general, backside cooling means that the catalyst is positioned on a surface in heat exchange with another surface. In the preferred embodiment the catalyst is deposited on a conduit made of metal, and a portion of the heat of reaction is conducted from the surface on which the catalyst is deposited to the opposite surface, which is in contact with the cooling stream.

### BRIEF DESCRIPTION OF THE DRAWINGS

FIG. 1 is a schematic representation of the basic method of the present invention.

FIG. 2 is a cross-sectional side view of a catalytic reactor for use with the present invention.

FIG. 3 is a graph of surface temperature of the catalyst within the catalytic reactor, for operation on two different fuels.

### DETAILED DESCRIPTION OF THE INVENTION

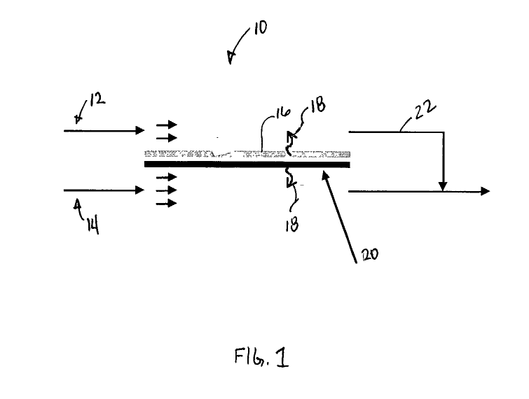

As shown in FIG. 1, the method, generally referred to by reference number 10, involves creating a fuel/air stream 12 that is a mixture of fuel and air in fuel rich proportions. An air stream 14 is also provided. The fuel/air stream 12 passes over a catalyst 16 suitable for promoting an oxidation reaction between the fuel and oxidant with the fuel/air stream thereby creating a heat of reaction 18.

The catalyst 16 is positioned at the surface of a heat conducting substrate 20. While the fuel/air stream 14 contacts one side of the heat conducting substrate 20, the air stream 14 contacts the opposite side. The heat of reaction 18 is conducted into the fuel/air stream 12 and through the heat conducting substrate 20 into the air stream 14.

As stated above, the catalyst 16 promotes an oxidation reaction between the fuel and air in the fuel/air mixture 12. This reaction creates a product stream 22 that is subsequently contacted with the air stream 14. The air stream 14 is of such a mass flow that the overall fuel/air ratio, entering fuel to entering air (all air) is lean.

In accordance with the method, the fuel within the fuel/air stream changes between at least two different fuels, but the catalyst remains the same. In operation, the method is first employed with one fuel and then is employed with a second fuel. Preferably, the fuels are selected such that the fuels have a similar heat release per mole of oxygen reacted to full combustion products.

The catalyst 16 must operate oxygen mass transfer limited. This means that the mass flow of the fuel/air stream 12 and the characteristics of the catalyst 16, such as loading and dispersion, must cooperate such that the available oxygen within the fuel/air stream controls the oxidation reaction over the catalyst.

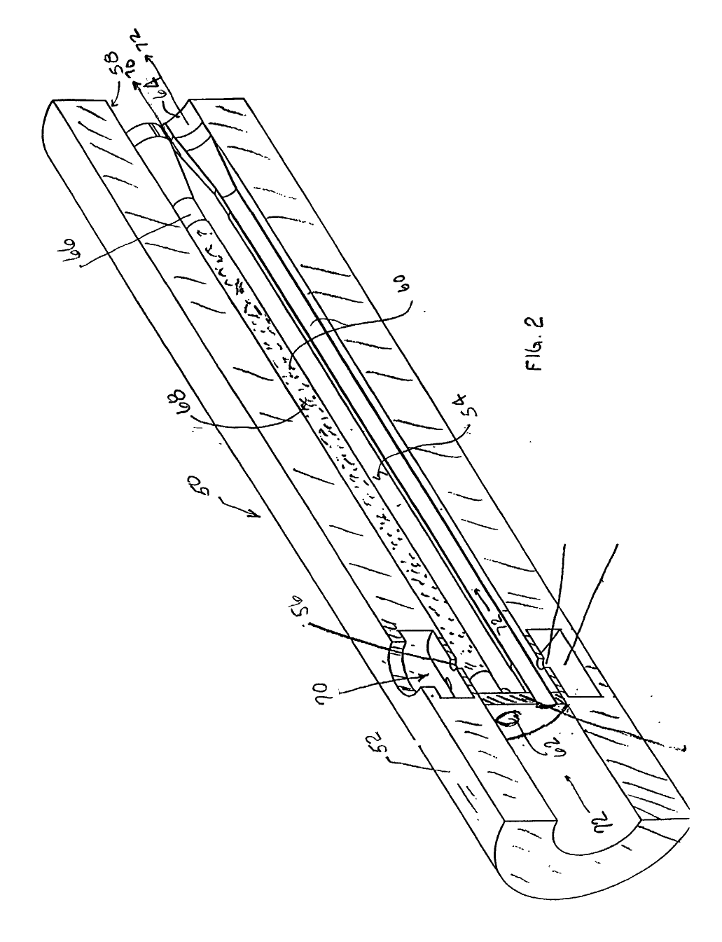

The method of the present invention is shown in conjunction with a fixed geometric catalytic reactor suitable for performing the method. As shown in FIG. 2, the catalytic reactor, generally denoted by the reference number 50, is comprised of a housing 52. The housing 52 defines a chamber 54, an entrance 56, and an exit 58. A plurality of conduits 60, each having a first opening 62, a second opening 64, and an exterior surface 66, penetrate the housing 52. The penetration is such that a portion of each conduit 60 is positioned within the chamber 54 with the first opening 62 outside the chamber 54 and the second opening 64 inside the chamber. A catalyst 68 is positioned on a portion of an exterior surface 66 of at least one conduit 60 within the chamber 54 between the first opening 62 and the second opening 64.

In this fixed geometry catalytic reactor, a fuel/air stream 70 enters through the entrance 56 and flows toward the exit 58. Additional air 72 flows into the entrance 62 of the conduit 60 passing through the conduit and exiting through the conduit exit 64. The mixture 70 contacts the additional oxidant 72 as the additional oxidant exits into the chamber 54. Mixing of the mixture 70 and additional oxidant 72 begins almost immediately.

As a general design rule, sufficient catalyst coating should be applied that the reactor operates oxygen mass transfer limited on all expected fuel types. As stated earlier, it is a requirement of the method that the reactor operate oxygen mass transfer limited on the two fuels used to practice the method. Sufficient catalyst coating means sufficient loading, on a weight basis, as well as sufficient specific surface area of catalyst. The required loading and the required specific surface area will depend upon operating conditions (e.g. reactant temperature, pressure, velocity, composition) and catalyst activity, and can be determined by methods known in chemical engineering practice.

The catalyst coating used in the present invention, where the fuel is hydrocarbon-based and oxygen is the oxidizer, may have as an active ingredient precious metals, group VIII noble metals, base metals, metal oxides, or any combination thereof. Elements such as zirconium, vanadium, chromium, manganese, copper, platinum, palladium, osmium, iridium, rhodium, cerium, lanthanum, other elements of the lanthanide series, cobalt, nickel, iron, and the like may be used. The catalyst may be applied directly to the substrate, or may be applied to an intermediate bond coat or washcoat composed of alumina, silica, zirconia, titania, magnesia, other refractory metal oxides, or any combination thereof.

The catalyst-coated substrate may be fabricated from any of various high temperature materials. High temperature metal alloys are preferred, particularly alloys composed of iron, nickel, and/or cobalt, in combination with aluminum, chromium, and/or other alloying materials. High temperature nickel alloys are especially preferred. Other materials which may be used include ceramics, metal oxides, intermetallic materials, carbides, and nitrides. Metallic substrates are most preferred due to their excellent thermal conductivity, allowing effective backside cooling of the catalyst.

Example of Dual-fuel Operation

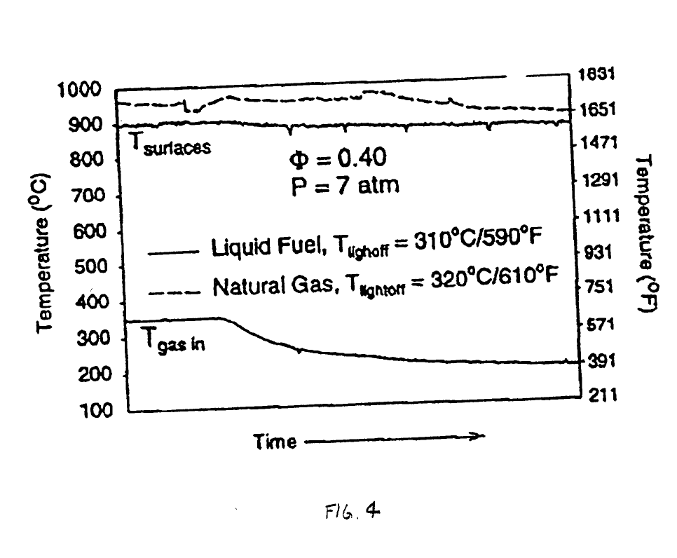

Data were obtained for a catalytic combustion system operating on two different fuels under the method of the present invention, using a backside-cooled catalytic reactor apparatus of the type depicted in FIG. 2. The reactor was operated on natural gas and on gasoline at different times. The data are shown in FIG. 3, in the form of catalyst operating temperature as a function of time for the two different fuels. Although the different fuels were used at different times, the time periods for natural gas operation and gasoline operation are overlapped (shown as concurrent) in FIG. 3 to allow comparison of the data.

For the tests shown in FIG. 3, the reactor was fabricated using seven (7) metal tubes coated with a platinum-based catalyst on their exterior surfaces. The tubes were 10 inches in length with an outside diameter of 0.188 inches and a material thickness of 0.010 inches. One end of each tube was expanded at a constant angle of 4 degrees until the diameter was locally increased about 30 percent, to a final outside diameter of about 0.25 inches. A flat segment was provided on the 0.25-inch diameter flared section of about 0.1 inches in length, and the seven (7) tubes were closely packed, in contact, at these flared segments within the downstream end of the reactor housing. At the upstream end, the tubes were brazed into a sealing plate, with the tube centerlines spaced apart by a distance equal to the tube centerline spacing at the closely packed downstream end, so that the tubes lay parallel to one another, but not touching along most of their length.

The reactor was operated at 7 atm pressure and 150 ft/s reference velocity, with a fuel-rich equivalence ratio of 2.6 in the fuel/air mixture which contacted the catalyst. Downstream of the catalyst, the cooling air stream and the product stream mixed to an overall equivalence ratio of 0.4 (giving an adiabatic flame temperature of about 1250° C. for natural gas fuel at 350° C. catalyst inlet temperature). Actual reactor inlet temperature is shown as a function of time in FIG. 3. The operating conditions were the same for both the gasoline fuel tests and the natural gas fuel tests. Note that the 150 ft/s reference velocity refers to the total flow of fuel and air (in the fuel/air mixture stream and in the cooling air stream) at the reactor inlet temperature, and within the reactor housing (but assuming zero thickness for catalyst and substrate). The cooling air stream backside cooled the catalyst by passing through the inside of the tubes.

The method of the present invention is shown in conjunction with a fixed geometric catalytic reactor suitable for performing the method. As shown in FIG. 3, the catalytic reactor, generally denoted by the reference number 50, is comprised of a housing 52. The housing 52 defines a chamber 54, an entrance 56, and an exit 58. A plurality of conduits 60, each having a first opening 62, a second opening 64, and an exterior surface 66 penetrate the housing 52 such that a portion of each conduit is positioned within the chamber 54 with the first opening 62 outside the chamber 54 and the second opening inside the chamber. A catalyst 68 is positioned on a portion of an exterior surface 66 of at least one conduit 60 within the chamber 54 between the first opening 62 and the second opening 64.

In general, the gasoline results showed similar operation to that obtained using natural gas fuel. FIG. 3 compares catalyst operation for both natural gas and gasoline, including operation at inlet temperatures down to below 200° C. (400° F.). For both fuels, lightoff occurred at a temperature near 320° C. (600° F.). As shown in the graph, catalyst operating temperatures were approximately the same for both fuels. For this example, the exact same catalytic reactor was used for both fuels, without removal from the test rig. Thus, the natural gas and gasoline fuels both reacted on the same catalyst in the same reactor within the same geometric envelope.

The above example shows that the method of the present invention provides a useful and previously unachieved result: safe catalyst operation (at temperatures below the material temperature limits) on two fuels having dissimilar reactivity in a single catalytic reactor passing all combustion fuel and air, and without cooling by fluids external to the combustion process, to achieve an overall adiabatic flame temperature downstream of the catalyst in excess of 1200° C.

Although the present invention has been described in considerable detail with reference to certain preferred versions thereof, other versions are possible. Therefore, the spirit and scope of the invention should not be limited to the description of the preferred versions contained herein.

What is claimed is:

1. A method for operating a catalytic reactor on two different fuels having dissimilar reactivity, one after the other, the method comprising the steps of:
a. mixing a first fuel with a first stream comprising air to create a fuel-rich fuel/air mixture;
b. contacting the fuel-rich fuel/air mixture with a backside-cooled catalyst to oxidize at least a portion of the fuel within the fuel-rich fuel/air mixture thereby creating a product stream and a heat of reaction, the reaction rate at the catalyst surface being oxygen mass transfer limited, the backside-cooled catalyst being cooled by a cooling stream comprising a second air stream;
c. conducting at least a portion of the heat of reaction into the cooling stream, the cooling stream being of sufficient flow rate to form a fuel-lean fuel/air mixture if mixed with the product stream;
d. contacting the product stream with the cooling stream; and
e. substituting a second fuel for the first fuel and repeating steps (a) through (d).

2. The method of claim 1 wherein greater than 50 percent of the heat of reaction is conducted to the cooling stream.

3. The method of claim 1 wherein the first fuel and the second fuel each have a heat release per mole of O₂ combusted between 80 and 120 kcal.

4. The method of claim 1 wherein the first fuel and the second fuel each have a heat release per mole of O₂ combusted between 90 and 110 kcal.

5. The method of claim 1 comprising the additional step of adding steam to the first stream.

6. The method of claim 1 comprising the additional step of adding steam to the cooling stream.

7. A method for operating a catalytic reactor on two different fuels having dissimilar reactivity, one after the other, the method comprising the steps of:
a. flowing a first fuel stream into a first stream comprising air, and mixing the first fuel stream with the first stream comprising air to create a first fuel-rich fuel/air mixture;
b. contacting the first fuel-rich fuel/air mixture with a backside-cooled catalyst to oxidize at least a portion of the fuel within the first fuel-rich fuel/air mixture thereby creating a first product stream and a first heat of reaction, the reaction rate at the catalyst surface being oxygen mass transfer limited, the backside-cooled catalyst being cooled by a cooling stream comprising a second air stream;
c. conducting at least a portion of the first heat of reaction into the cooling stream, the cooling stream being of sufficient flow rate to form a first fuel-lean fuel/air mixture if mixed with the first product stream;
d. contacting the first product stream with the cooling stream;
e. stopping the flow of the first fuel;
f. flowing a second fuel stream into the first air stream, and mixing the second fuel stream with the first air stream to create a second fuel-rich fuel/air mixture;
g. contacting the second fuel-rich fuel/air mixture with the backside-cooled catalyst to oxidize at least a portion of the fuel within the second fuel-rich fuel/air mixture thereby creating a second product stream and a second heat of reaction, the reaction rate at the catalyst surface being oxygen mass transfer limited, the backside-cooled catalyst being cooled by the cooling stream;
h. conducting at least a portion of the second heat of reaction into the cooling stream, the cooling stream being of sufficient flow rate to form a second fuel-lean fuel/air mixture if mixed with the second product stream; and
i. contacting the second product stream with the cooling stream.

8. The method of claim 7 wherein greater than 50 percent of the first heat of reaction is conducted to the cooling stream, and greater than 50 percent of the second heat of reaction is conducted to the cooling stream.

9. The method of claim 7 wherein the first fuel and the second fuel each have a heat release per mole of O₂ combusted between 80 and 120 kcal.

10. The method of claim 7 wherein the first fuel and the second fuel each have a heat release per mole of O₂ combusted between 90 and 110 kcal.

11. A method for operating a catalytic reactor on two different fuels, one after the other, the method comprising the steps of:
a. mixing a first fuel with a first stream comprising air to create a fuel-rich fuel/air mixture;
b. contacting the fuel-rich fuel/air mixture with a backside-cooled catalyst to oxidize at least a portion of the fuel within the fuel-rich fuel/air mixture thereby creating a product stream and a heat of reaction, the reaction rate at the catalyst surface being controlled to limit surface temperature by limiting oxygen mass transfer to the surface, the backside-cooled catalyst being cooled by a cooling stream comprising a second air stream;
c. conducting at least a portion of the heat of reaction into the cooling stream, the cooling stream being of sufficient flow rate to form a fuel-lean fuel/air mixture if mixed with the product stream;
d. contacting the product stream with the cooling stream; and
e. substituting a second fuel for the first fuel and repeating steps (a) through (d).
